(19) United States
(12) Patent Application Publication
(10) Pub. No.: US 2009/0212645 A1
(43) Pub. Date: Aug. 27, 2009

(54) ELECTRONIC DEVICE FOR HARVESTING ENERGY

(75) Inventor: Horst Theuss, Wenzenbach (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Neubiberg (DE)

(21) Appl. No.: 12/038,275

(22) Filed: Feb. 27, 2008

(51) Int. Cl. H02K 35/02; H02K 15/00

(52) U.S. Cl. 310/15; 29/596

(57) ABSTRACT

An electrical device for harvesting energy includes a container, a magnet situated in the container, a fluid partially filling the container, and a conductive member coiled around the container, wherein oscillation of the magnet through the coil induces an electrical signal.

### BACKGROUND

The production of electrical energy from the surroundings without utilization of a battery is a form of energy harvesting. Energy harvesting, also known as power harvesting or energy scavenging, is the process by which energy is captured and stored. Energy harvesting makes it possible to drive electric systems without the necessity of a battery or a more restricted accumulator. Energy harvesting systems conventionally use thermoelectricity or mechanical vibrations which are converted to electric energy.

Some electrical generating systems make use of reciprocating magnet movement through one or more coils. The movement of a magnet through a conductive coil induces a current flow in the coil. The coupling of the mechanical energy through an inert mass is usually done by means of a mechanical feather or spring. If the magnet is moved back and forth in a reciprocating motion, the direction of current flow in the coil will be reversed for each successive traverse, yielding an AC current.

Previous inventions were limited due to friction and gravitational force and implemented springs or magnets in polar opposition to suspend and support the magnets used to generate the energy.

For these and other reasons, there is a need for the present invention.

### SUMMARY

Embodiments of the present invention include an electronic device including a container, a fluid partially filling the container, a conductive member coiled around the container, and a magnet suspended in the fluid, such that oscillation of the magnet through the coil induces an electrical signal.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a diagrammatic representation of an energy harvesting system.

FIG. 2a is a view of an electrical device for harvesting energy according to one embodiment.

FIG. 2b is a view of an electrical device for harvesting energy according to one embodiment, including representative field-lines.

FIG. 3a is a view of an electrical device for harvesting energy according to one embodiment.

FIG. 3b is a view of an electrical device for harvesting energy according to one embodiment, including the representative field-lines.

FIG. 4 is a view of an electrical device for harvesting energy according to one embodiment.

FIG. 5 is a view of an electrical device for harvesting energy according to one embodiment, including representative field-lines.

FIG. 6 is a view of an electrical device for harvesting energy according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

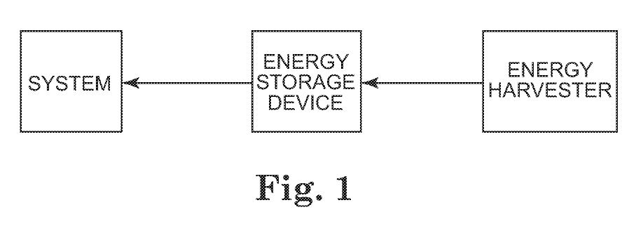

FIG. 1 is a diagrammatic representation of an implementation of an energy harvesting system in accordance with embodiments of the invention. The system is supplied energy from the energy storage device. The system for which energy is supplied may be any device which requires energy and is subject to some degree of movement or vibration, for example, a tire pressure sensor or some independent machine. The inductive energy harvester may be applicable in situations where there is not easy access to other types of power although its application can be anywhere energy harvesting is sought. The energy storage device stores the electrical energy generated by the energy harvester. The energy storage device may a capacitor, for example. The energy harvester provides for conversion of mechanical vibrations to electrical energy.

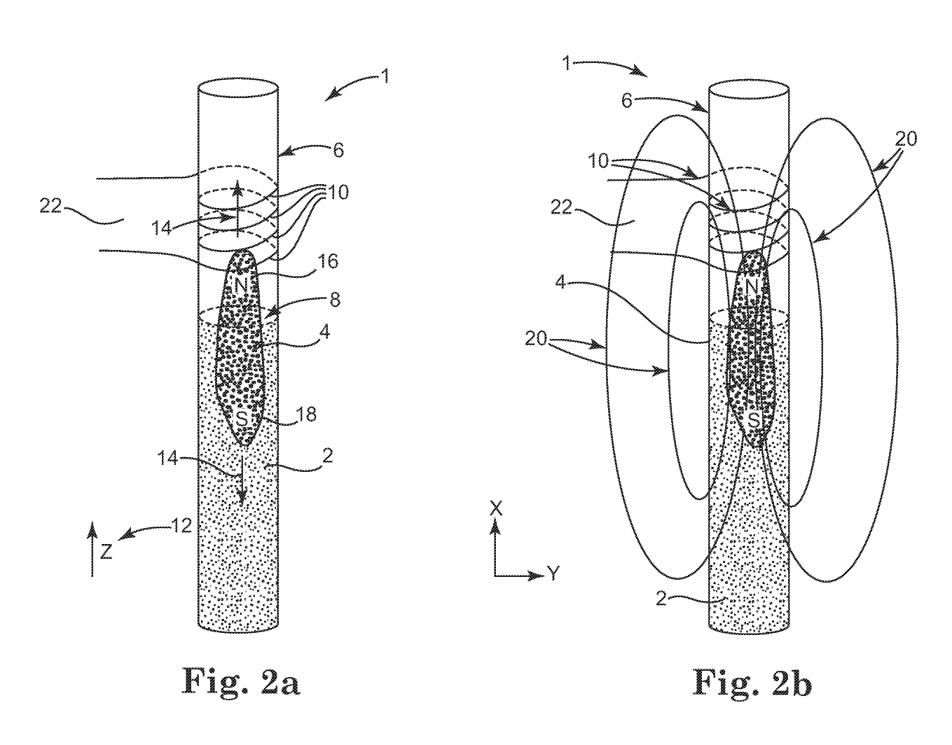

FIGS. 2a and 2b are representations of an inductive energy harvester 1 according to one embodiment. The energy harvester 1 includes a container 6, a magnet 4 situated in the container 6, a fluid 2 partially filling the container 6, a conductive member 10 coiled around the container 6, such that oscillation of the magnet 4 through the coil 10 induces an electrical signal. The container 6 may be plastic, glass, non-magnetic metal or other non-magnetic material, for example. In one embodiment, each magnet 4 has a length such that polar reversal of the magnet 4 within the container 6 is prevented and orientation of the north polarity 16 and the south polarity 18 is maintained within the container 6. In one embodiment rare earth magnets are used. Examples of rare earth magnets include samarium-cobalt or neodymium-iron-boron.

The magnet 4 is suspended in a fluid 2, eliminating the need for other mechanical suspension, such as springs. The provision of the fluid 2 reduces friction between the magnet 4 and the container 6 as well as reducing the effects of gravity upon the magnet 4. In one embodiment, the fluid 2 includes ferrofluid. Ferrofluids are dispersions of finely divided magnetic or magnetizable particles dispersed in a liquid carrier. In one embodiment, the fluid 2 is in one or several containers 6, which, may be tubes or capillaries or other vessels which will contain the fluid 2. In one embodiment, multiple containers may be implemented to harvest the level of energy desired.

In one embodiment, the magnet system 1 includes a fluid 2 partially filling a container 6 and a magnet 4 is suspended such that the magnet 4 is movable in a linear Z-direction 12. In one embodiment, the density of the magnet 4 is such that it is less than the density of the fluid 2. As shown in FIG. 2b, magnetic field lines 22 are generated by the magnet 4. Through surface-level 8 fluctuations of the fluid 2 within the container 6, the magnet 4 vibrates in a Z-direction 12 and generates an induction-tension in a coil 10. Electrically conductive coils 10 are placed around the container 6 which is connected to a capacitor 22 to store the energy generated.

The energy harvester 1 provides for the conversion of mechanical vibrations to electric energy through the movement or oscillation of the magnet 4 suspended in a fluid 2 through the coils 10. The inductive energy harvester 1 is provided with magnets 4 that are stored in a fluid 2 and generate an inductive change-tension with fluctuations of the liquid surface 8 in a coil 10. Oscillation of the magnets 4 may be caused by vibration or other movement of the container 6. For example, the container 6 may be mounted to industrial machines, tires or other items which have movement, and thereby will cause movement to the container 6. The magnet 4 is sized such that polar reversing of the magnets 4 within the container 6 is largely prevented. For example, in the illustrated embodiments, the magnet 4 has a length that is longer than the width of the container 6, thus preventing the magnet 4 from turning in the container 6 as the magnet oscillates back and forth in the container 6.

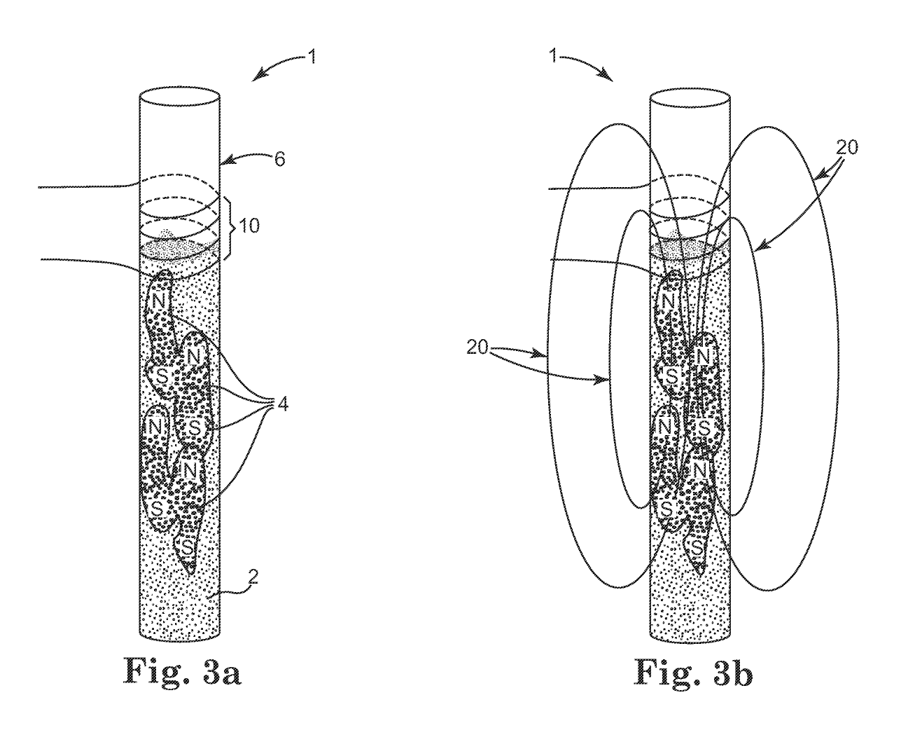

FIGS. 3a and 3b are views of an energy harvester, with and without representative magnetic field-lines, according to one embodiment. In one embodiment, more than one magnet 4 is used. In this manner, polar pairing of the magnets 4 may occur. The effective magnetic field 20 results from the sum of the fields of the single magnets 4. Since the container 6 is only partially filled with fluid 2, mechanical vibrations lead to fluctuations of the liquid surface 8 and with it the movement of the magnets 4. One or more electrically conductive coils 10 are wrapped around the container 6 such that an electric induction tension is generated which can be stored as electrical energy in a capacitor 22.

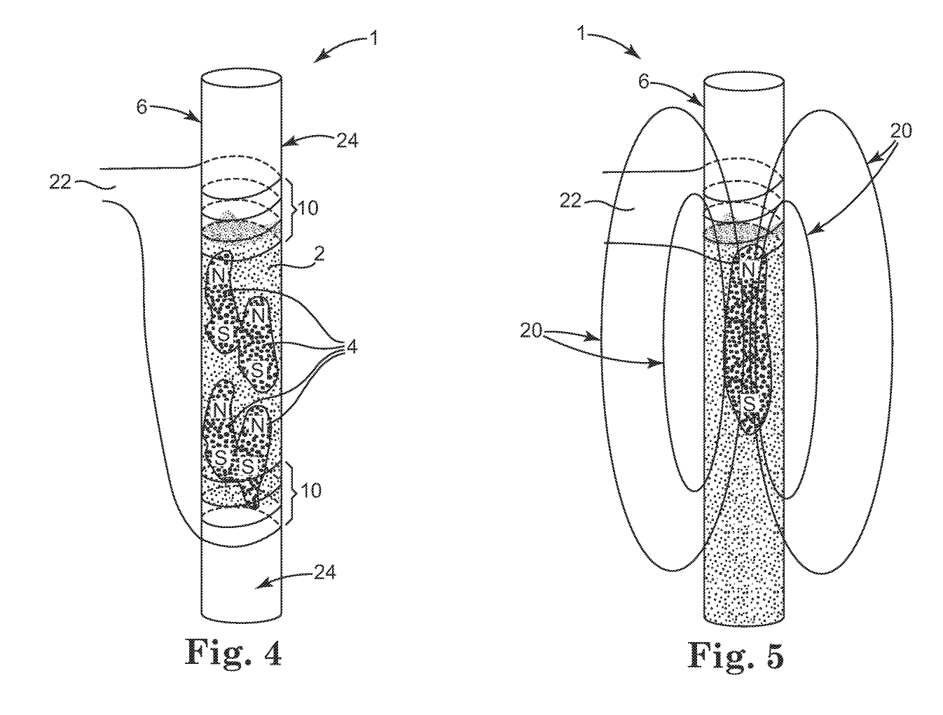

FIG. 4 is a view of an energy harvester according to one embodiment. The portions of fluid 2 within the container 6 segmented by a gaseous substance 24. In one embodiment the magnets 4 are fully encapsulated within the fluid 2.

FIG. 5 is a view of an energy harvester according to one embodiment. The density of the magnet 4 is similar to the density of the fluid 2. In this manner the suspension of the magnet 4 within the fluid 2 is different than that of FIG. 1.

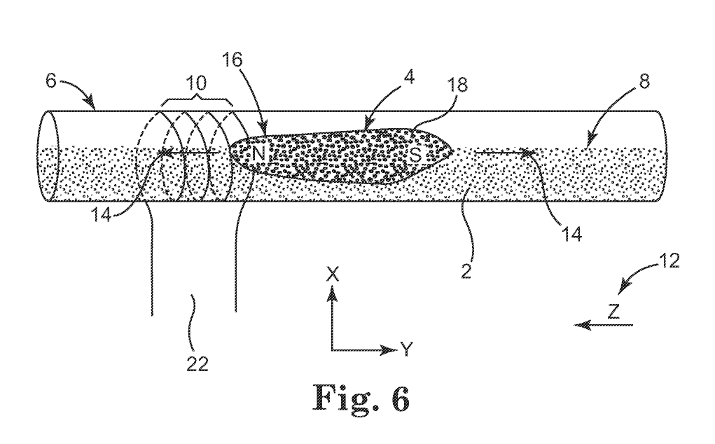

FIG. 6 is a view of an energy harvester according to one embodiment. In this embodiment the container 6 is horizontal. The orientation of the container 6 may be vertical, horizontal or any other alignment. Gravitational effects in this embodiment are minimized through the suspension of the magnets 4 in the fluid 2. Advantages of this system are realized by the flexibility of the energy harvester's orientation in order to maximize the energy production. Other advantages to this system are realized by not having complicated and poorly configured spring like suspension. The direction of the vibration is generally the same direction container orientation such that it is not dependent on the force of gravity. The orientation of the container 6, for example, is such that the vibrations are maximally effected on the container 6 and subsequent energy generation. The fluid 2 has a surface face 8 which may be perpendicular to the surfaces of the container 6 it is in contact with, but does not necessarily have to be perpendicular. Instead the container will be oriented such that it maximizes the effect of the movement causing the magnets' oscillations.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An electronic device, comprising:
a container;
a conductive member coiled around the container;
a fluid partially filling the container; and
a magnet at least partially submerged in the fluid so that the magnet is suspended in the fluid, such that oscillation of the magnet through the coil to induces an electrical signal.

2. The electronic device of claim 1, wherein the magnet is movable in a linear direction.

3. The electronic device of claim 1, wherein the magnet has a length that is longer than a width of the container, such that the magnet cannot reverse polarity within the container.

4. The electronic device of claim 1, further comprising a capacitor coupled to the electrically conductive coil for storing the electrical signal.

5. The electronic device of claim 1, further comprising a plurality of magnets suspended in the fluid with the same polar orientation.

6. The electronic device of claim 5, wherein polar pairing of the magnets occurs within the container.

7. The electronic device of claim 1, wherein the magnet is a rare earth magnet.

8. The electronic device of claim 1, wherein the fluid is a ferrofluid.

9. The electronic device of claim 1, wherein the magnet has a density that is less than or equal to a density of the fluid.

10. The electronic device of claim 1, wherein the fluid is segmented by gaseous pockets.

11. The electronic device of claim 1, wherein the container is composed of non-magnetic material.

12. The electronic device of claim 1, wherein the conductive member includes a plurality of conductive members coiled around the container in a spaced apart relationship.

13. A method for producing an electronic device, comprising:
partially filling a container with a fluid;
coiling a conductive member around the container;
situating a magnet in the fluid such that the magnet is at least partially submerged and suspended in the fluid, wherein movement of the magnet inside the container induces an electrical signal in the coil.

14. The method of claim 13, wherein suspending the magnet in the fluid includes sizing the magnet such that the magnet cannot reverse polarity within the container.

15. The method of claim 13, wherein suspending the magnet in the fluid includes suspending a plurality of magnets in the fluid with the same polar orientation.

16. The method of claim 13, further comprising storing the electrical signal in a capacitor.

17. The method of claim 13, further comprising segmenting the fluid with gaseous pockets.

18. The method of claim 13, wherein coiling the conductive member around the container includes coiling a plurality of conductive members around the container to form a plurality of spaced-apart conductive coils.

19. A method for harvesting energy, comprising:
providing a container partially filled with a fluid and having a conductive member coiled around the container;
moving the container to induce movement of a magnet that is at least partially submerged and suspended in the fluid, such that the magnet moves through the conductive member; and
storing an electrical signal induced in the coil by the magnet moving through the coil.

20. The method of claim 19, wherein storing the electrical signal includes charging a capacitor coupled to the conductive member.

21. An energy harvesting system, comprising:
a container;
a magnet situated in the container;
a conductive member coiled around the container; and
means for suspending the magnet in the container, such that oscillation of the magnet through the coil induces an electrical signal in the coil.

22. The electronic device of claim 1, wherein the magnet is completely submerged in the fluid.

23. The electronic device of claim 1, wherein the fluid fills at least half of the container.
